(19) United States
(12) Patent Application Publication
(10) Pub. No.: US 2017/0011465 A1
(43) Pub. Date: Jan. 12, 2017

(54) METHOD AND APPARATUS FOR PROVIDING FEE RATE BASED ON SAFETY SCORE

(71) Applicant: HERE Global B.V., Veldhoven (NL)

(72) Inventors: Anton ANASTASSOV, Naperville, IL (US); Leon STENNETH, Chicago, IL (US); Eric LINDER, Downers Grove, IL (US)

(21) Appl. No.: 14/794,466

(22) Filed: Jul. 8, 2015

(51) Int. Cl. G06Q 40/08

(52) U.S. Cl. CPC G06Q 40/08

(57) ABSTRACT

An approach is provided for determining safety scores for locations, frequency of users traversing the locations, or a combination thereof to calculate fee rates. The approach involves determining at least one safety score associated with one or more locations, at least one user traversing the one or more locations, or a combination thereof. The approach also involves determining at least one frequency of traversal of the at least one location by the at least one user. The approach further involves causing, at least in part, a calculation of at least one fee rate for the at least one user based, at least in part, on the at least one safety score and the at least one frequency of traversal.

### BACKGROUND

With the advancement of vehicular and driver sensing technologies, fee authorities (e.g., insurance companies etc.) are finding new ways for adjusting fee rates (e.g., policy premiums). One area of interest has been implementation of accident prone locations (e.g., links, intersections, segments, etc.) and frequency of users traversing these accident prone locations towards calculation of fee rates.

### SOME EXAMPLE EMBODIMENTS

Therefore, there is a need for an approach for determining safety scores for locations, frequency of users traversing the locations, or a combination thereof to calculate fee rates.

According to one embodiment, a method comprises determining at least one safety score associated with one or more locations, at least one user traversing the one or more locations, or a combination thereof. The method also comprises determining at least one frequency of traversal of the at least one location by the at least one user. The method further comprises causing, at least in part, a calculation of at least one fee rate for the at least one user based, at least in part, on the at least one safety score and the at least one frequency of traversal.

According to another embodiment, an apparatus comprises at least one processor, and at least one memory including computer program code for one or more computer programs, the at least one memory and the computer program code configured to, with the at least one processor, cause, at least in part, the apparatus to determine at least one safety score associated with one or more locations, at least one user traversing the one or more locations, or a combination thereof. The apparatus is also caused to determine at least one frequency of traversal of the at least one location by the at least one user. The apparatus is further caused to cause, at least in part, a calculation of at least one fee rate for the at least one user based, at least in part, on the at least one safety score and the at least one frequency of traversal.

According to another embodiment, a computer-readable storage medium carries one or more sequences of one or more instructions which, when executed by one or more processors, cause, at least in part, an apparatus to determine at least one safety score associated with one or more locations, at least one user traversing the one or more locations, or a combination thereof. The apparatus is also caused to determine at least one frequency of traversal of the at least one location by the at least one user. The apparatus is further caused to cause, at least in part, a calculation of at least one fee rate for the at least one user based, at least in part, on the at least one safety score and the at least one frequency of traversal.

According to another embodiment, an apparatus comprises means for determining at least one safety score associated with one or more locations, at least one user traversing the one or more locations, or a combination thereof. The apparatus also comprises means for determining at least one frequency of traversal of the at least one location by the at least one user. The apparatus further comprises means for causing, at least in part, a calculation of at least one fee rate for the at least one user based, at least in part, on the at least one safety score and the at least one frequency of traversal.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of determining safety scores for locations, frequency of users traversing the locations, or a combination thereof to calculate fee rates, according to one embodiment;

FIG. 1B is a diagram of the geographic database 111 of system 100, according to exemplary embodiments;

FIG. 2 is a diagram of the components of the evaluation platform 109, according to one embodiment;

FIG. 3 is a flowchart of a process for determining safety score, frequency information, or a combination thereof to calculate fee rate, according to one embodiment;

FIG. 4 is a flowchart of a process for determining frequency of traversal in one or more locations by one or more users, according to one embodiment;

FIG. 5 is a flowchart of a process for collecting and transmitting sensor data to a fee authority associated with a fee rate, according to one embodiment;

FIG. 6 is a flowchart of a process for determining the duration a safety score is outside a standard safety score window, according to one embodiment;

FIG. 7 is a diagram that represents a scenario wherein safety score for at least one vehicle is determined based on the attributes of a location, according to one example embodiment;

FIG. 8 is a diagram that represents a scenario wherein safety score for at least one vehicle is determined based on presence of other vehicles in the location, according to one example embodiment;

FIGS. 9 A-D are diagrams that represent a scenario wherein safety score for one or more vehicles is calculated based on user behavior, according to one example embodiment;

FIG. 10 is a graphical diagram that represents the steps for computing an accident potential score or an accident potential category at the link level, according to one example embodiment;

FIGS. 11 A-C are graphical diagrams that represents different drivers (1101, 1103, 1105), the links that were traversed as determined by the map matching process (1107, 1109, 1111), and the frequency of drives on these links (1113, 1115, 1117), according to one example embodiment;

FIG. 12 is a diagram of hardware that can be used to implement an embodiment of the invention;

FIG. 13 is a diagram of a chip set that can be used to implement an embodiment of the invention; and

FIG. 14 is a diagram of a mobile terminal (e.g., handset) that can be used to implement an embodiment of the invention.

### DESCRIPTION OF SOME EMBODIMENTS

Examples of a method, apparatus, and computer program for determining safety scores for locations, frequency of users traversing the locations, or a combination thereof to calculate fee rates are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

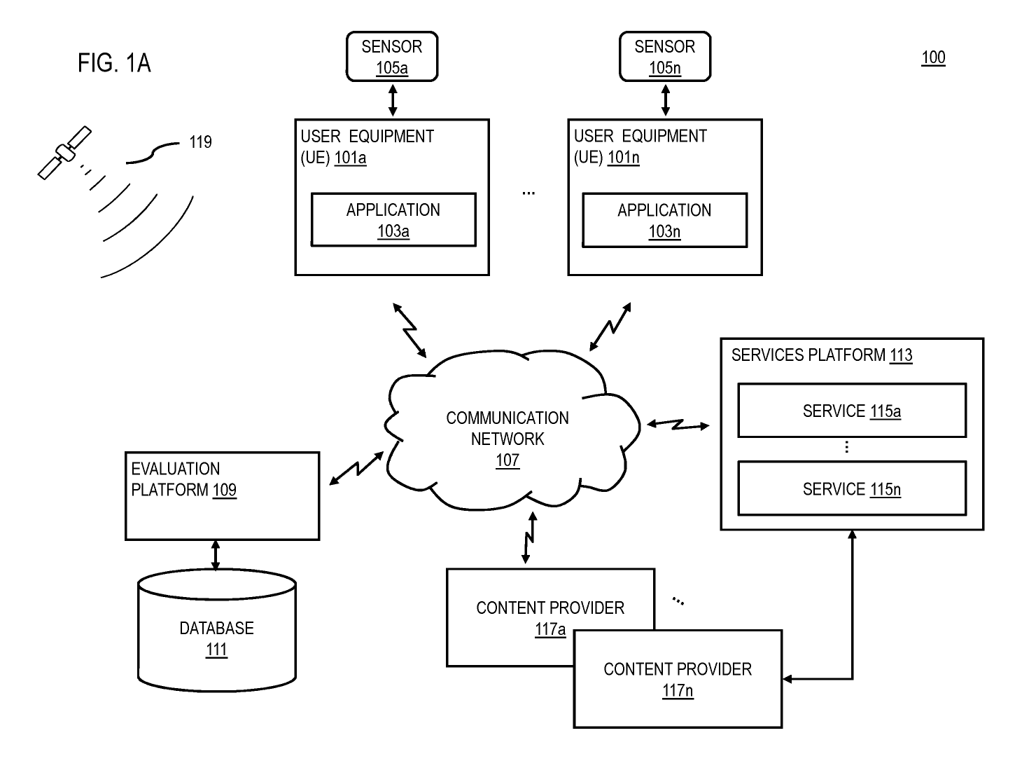

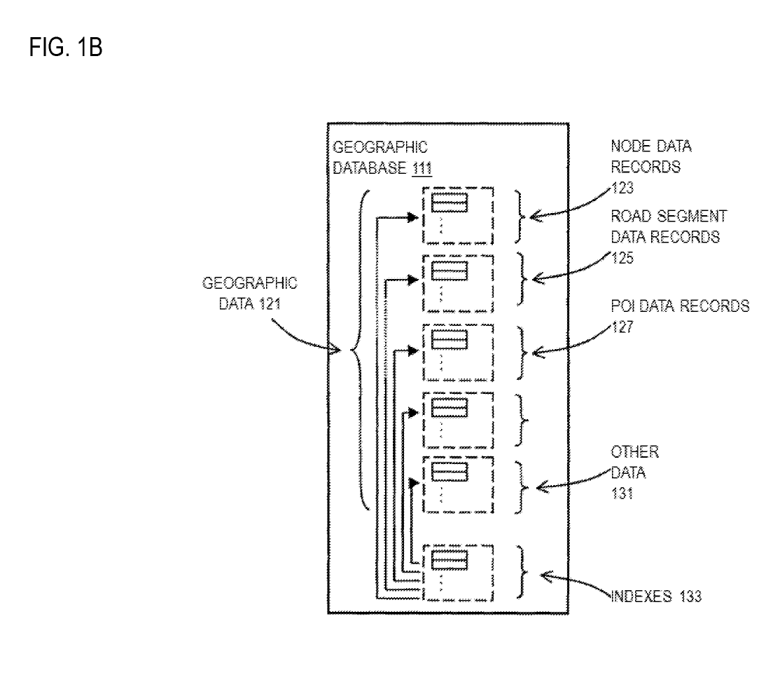

FIG. 1A is a diagram of a system capable of determining safety scores for locations, frequency of users traversing the locations, or a combination thereof to calculate fee rates, according to one embodiment. Presently, with pay-as-you-drive plans, the fee authorities typically require drivers to plug in a small telematics device into the vehicle's on-board diagnostic port. The device monitors the vehicle operator's driving behavior and records data like speed, cornering and braking patterns over a specified time period. If a driver always breaks hard and sudden, then he/she pays more on insurance fee than a driver who breaks smoothly. Since, fee authorities (e.g., automotive insurance providers) are interested in pay-as-you-drive policies due to the proliferation of vehicle sensing technologies, a system 100 of FIG. 1A introduces the capability to calculate fee rates (e.g., insurance policy) based on how frequent a user traverses on locations with high accident potential. In one scenario, system 100 of FIG. 1A determines accident prone locations, and scores the locations based on their accident potential. Then, system 100 of FIG. 1A determines the frequency at which a driver traverses these links. Subsequently, system 100 of FIG. 1A causes a personalized fee rate adjustment based, at least in part, on the accident potential scores, frequency at which a driver traverses accident prone locations, or a combination thereof. In one scenario, pay-as-you-drive did not consider high accident locations, and focused only on driving style attributes of users, such as, how smooth the driver applies the brake. This new method of adjusting fee rates provides additional relevant information to evaluate the risks.

As shown in FIG. 1A, the system 100 comprises user equipment (UE) 101a-101n (collectively referred to as UE 101) that may include or be associated with applications 103a-103n (collectively referred to as applications 103) and sensors 105a-105n (collectively referred to as sensors 105). In one embodiment, the UE 101 has connectivity to the evaluation platform 109 via the communication network 107. In one embodiment, the evaluation platform 109 performs one or more functions associated with determining safety scores for locations, frequency of users traversing the locations, or a combination thereof to calculate fee rates. In one scenario, a user may be a driver, an autonomous vehicle, or a combination thereof.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that the UE 101 can support any type of interface to the user (such as “wearable” circuitry, etc.). In one embodiment, the one or more vehicles may have cellular or Wi-Fi connection either through the inbuilt communication equipment or from the UE 101 associated with the vehicles. The applications 103 may assist in conveying sensor information via the communication network 107.

By way of example, the applications 103 may be any type of application that is executable at the UE 101, such as mapping application, location-based service applications, navigation applications, content provisioning services, camera/imaging application, media player applications, social networking applications, calendar applications, and the like. In one embodiment, one of the applications 103 at the UE 101 may act as a client for the evaluation platform 109 and perform one or more functions associated with the functions of the evaluation platform 109 by interacting with the evaluation platform 109 over the communication network 107.

By way of example, the sensors 105 may be any type of sensor. In certain embodiments, the sensors 105 may include, for example, a global positioning sensor for gathering location data, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., information on road attribute can be populated by highly assisted vehicles that have cameras and image recognition techniques), an audio recorder for gathering audio data, velocity sensors, and the like. In another embodiment, the sensors 105 may include light sensors, oriental sensors augmented with height sensor and acceleration sensor (e.g., an accelerometer can measure acceleration and can be used to determine orientation of the UE 101), tilt sensors to detect the degree of incline or decline of the vehicle along a path of travel, moisture sensors, pressure sensors, etc. In a further example embodiment, sensors about the perimeter of the vehicle may detect the relative distance of the vehicle from lanes or roadways, the presence of other vehicles, pedestrians, traffic lights, road features (e.g., curves) and any other objects, or a combination thereof. In one scenario, the sensors 105 may detect weather data, traffic information, or a combination thereof. In one example embodiment, the UE 101 may include GPS receivers to obtain geographic coordinates from satellites 119 for determining current location and time associated with the UE 101. Further, the location can be determined by a triangulation system such as A-GPS, Cell of Origin, or other location extrapolation technologies. In another example embodiment, the one or more sensors may provide in-vehicle navigation services, wherein one or more location based services may be provided to the at least one vehicle and/or at least one UE 101 associated with the at least one vehicle.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the evaluation platform 109 may be a platform with multiple interconnected components. The evaluation platform 109 may include multiple servers, intelligent networking devices, computing devices, components and corresponding software for determining safety scores for locations (e.g., travel segments, road segments, a point (i.e. latitude/longitude), intersections, sidewalks, bicycle lanes, etc.), frequency of users traversing the locations, or a combination thereof to calculate fee rates. In addition, it is noted that the evaluation platform 109 may be a separate entity of the system 100, a part of the one or more services 115a-115n (collectively referred to as services 115) of the services platform 113, or included within the UE 101 (e.g., as part of the applications 103), or included in a calculation system of a fee authority.

In one embodiment, the evaluation platform 109 may determine at least one safety score associated with one or more locations, at least one user traversing the one or more locations, or a combination thereof. In one scenario, the evaluation platform 109 may determine accident potential for one or more locations. The one or more locations include one or more travel segments, one or more intersections, one or more nodes, or a combination thereof. The safety score measures the capability for the one or more vehicle, the one or more users, or a combination thereof to have an accident in the one or more locations at a certain time period. In one scenario, the capability for one or more vehicles and/or one or more users to be in an accident is based, at least in part, on the probability for an accident to occur. In one embodiment, the safety score incorporates the accident potential score, any accident potential data, any contextual parameters, or a combination thereof.

In one embodiment, the evaluation platform 109 may determine at least one frequency of traversal of the at least one location by the at least one user. In one scenario, the evaluation platform 109 may cause a ranking of the one or more locations based, at least in part, on their accident potential. For example, at least one location with high accident potential is ranked higher; at least one location with low accident potential is ranked lower. Then, the evaluation platform 109 determines frequency of the one or more vehicles, the one or more users, or a combination thereof travelling in the one or more ranked locations based, at least in part, on map matching, historical location data, or a combination thereof.

In one embodiment, the evaluation platform 109 may cause, at least in part, a calculation of at least one fee rate for the at least one user based, at least in part, on the at least one safety score and the at least one frequency of traversal. In one scenario, the evaluation platform 109 may calculate safety score for the one or more vehicles, the one or more users, or a combination thereof based, at least in part, on the frequency of travel in the one or more ranked locations. In one example embodiment, the evaluation platform 109 may calculate insurance rate for one or more vehicles, one or more users, or a combination thereof travelling in the one or more locations with safety scores.

In one embodiment, the geographic database 111 stores information on locations (e.g., road length, road breadth, slope information, curvature information, etc.), probe data for one or more locations (e.g., traffic density information), historical accident data, and traffic sign information alongside the locations. In another embodiment, the geographic database 111 stores information on the frequency of travel in the one or more locations by the one or more users. The information may be any multiple types of information that can provide means for aiding in the content provisioning and sharing process. In another embodiment, the geographic database 111 may be in a cloud and/or in a vehicle (e.g., cars) and/or a mobile device (e.g., phone).

The services platform 113 may include any type of service. By way of example, the services platform 113 may include mapping services, navigation services, travel planning services, notification services, social networking services, content (e.g., audio, video, images, etc.) provisioning services, application services, storage services, contextual information determination services, location based services, information (e.g., weather, news, etc.) based services, etc. In one embodiment, the services platform 113 may interact with the UE 101, the evaluation platform 109 and the content provider 117 to supplement or aid in the processing of the content information.

By way of example, the services 115 may be an online service that reflects interests and/or activities of users. The services 115 allow users to share location information (e.g., speed information), activities information (e.g., travel plans), contextual information, historical user information and interests within their individual networks, and provides for data portability. The services 115 may additionally assist in providing the evaluation platform 109 with information on travel plans of at least one user, activity information for at least one user in at least one location, speed information for at least one user, user profile information, and a variety of additional information.

The content providers 117a-117n (collectively referred to as content provider 117) may provide content to the UE 101, the evaluation platform 109, and the services 115 of the services platform 113. The content provided may be any type of content, such as, image content (e.g., maps), textual content, audio content, video content, etc. In one embodiment, the content provider 117 may provide content that may supplement content of the applications 103, the sensors 105, or a combination thereof. In one embodiment, the content provider 117 may also store content associated with the UE 101, the evaluation platform 109, and the services 115 of the services platform 113. In another embodiment, the content provider 117 may manage access to a central repository of data, and offer a consistent, standard interface to data, such as, attributes, probe data, and traffic sign information for one or more locations.

By way of example, the UE 101, the evaluation platform 109, the services platform 113, and the content provider 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

FIG. 1B is a diagram of the geographic database 111 of system 100, according to exemplary embodiments. In the exemplary embodiments, POIs and map generated POIs data can be stored, associated with, and/or linked to the geographic database 111 or data thereof. In one embodiment, the geographic or map database 111 includes geographic data 121 used for (or configured to be compiled to be used for) mapping and/or navigation-related services, such as for personalized route determination, according to exemplary embodiments. For example, the geographic database 111 includes node data records 123, road segment or link data records 125, POI data records 127, and other data records 131, for example. More, fewer or different data records can be provided. In one embodiment, the other data records 131 include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example.

In exemplary embodiments, the road segment data records 125 are links or segments representing roads, streets, parking areas, or paths, as can be used in the calculated route or recorded route information for determination of one or more personalized routes, according to exemplary embodiments. The node data records 123 are end points corresponding to the respective links or segments of the road segment data records 125. The road segment data records 125 and the node data records 123 represent a road network, such as used by vehicles, cars, and/or other entities. Alternatively, the geographic database 111 can contain path segment and node data records or other data that represent pedestrian paths or areas in addition to or instead of the vehicle road record data, for example.

The travel segment and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, parking areas (attributes on which parking areas are critical) etc. The geographic database 111 can include data about the POIs and their respective locations in the POI data records 127. The geographic database 111 can also include data about places, such as cities, towns, or other communities, and other geographic features, such as bodies of water, mountain ranges, etc. Such place or feature data can be part of the POI data 127 or can be associated with POIs or POI data records 127 (such as a data point used for displaying or representing a position of a city).

The geographic database 111 can be maintained by the content provider in association with the services platform 113 (e.g., a map developer). The map developer can collect geographic data to generate and enhance the geographic database 111. There can be different ways used by the map developer to collect data. These ways can include obtaining data from other sources, such as municipalities or respective geographic authorities (e.g., designated parking areas). In addition, the map developer can employ field personnel to travel by vehicle along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database 111 or data in the master geographic database 111 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As mentioned above, the geographic database 111 can be a master geographic database, but in alternate embodiments, the geographic database 111 can represent a compiled navigation database that can be used in or with end user devices (e.g., UEs 101) to provided navigation-related functions. For example, the geographic database 111 can be used with the UE 101 to provide an end user with navigation features. In such a case, the geographic database 111 can be downloaded or stored on the UE 101, such as in the applications 103, or the UE 101 can access the geographic database 111 through a wireless or wired connection (such as via a server and/or the communication network 107), for example.

In one embodiment, the end user device or UE 101 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the navigation device UE 101 can be a cellular telephone. An end user can use the device UE 101 for navigation functions, for example, location map updates.

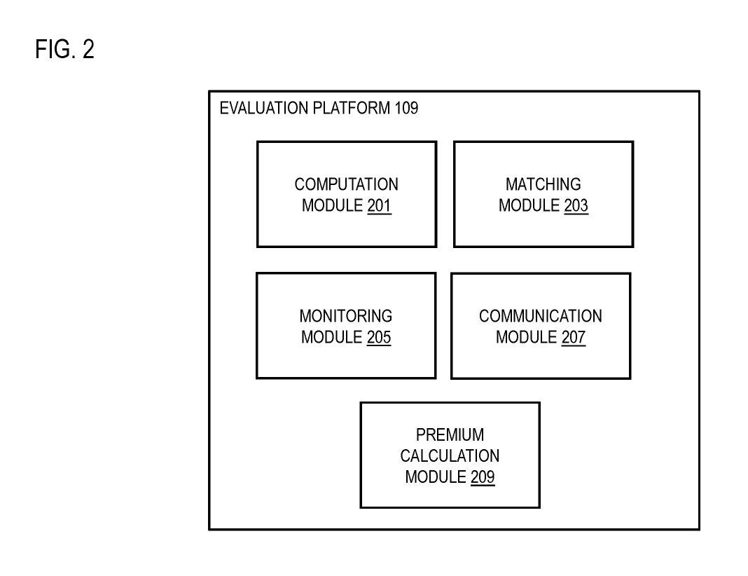

FIG. 2 is a diagram of the components of the evaluation platform 109, according to one embodiment. By way of example, the evaluation platform 109 includes one or more components for determining safety scores for locations, frequency of users traversing the locations, or a combination thereof to calculate fee rates. It is contemplated that the functions of these components may be combined in one or more components or performed by other components of equivalent functionality. In this embodiment, the evaluation platform 109 includes a computation module 201, a matching module 203, a monitoring module 205, a communication module 207, and a premium calculation module 209.

In one embodiment, the computation module 201 may determine whether at least one travel segment, at least one intersection, or a combination thereof associated with location contributes heavily to accidents. Then, the computation module 201 may assign safety score to the at least one travel segment, at least one intersection, or a combination thereof associated with the location. In one example embodiment, the safety score for a particular region may be provided to an insurance company. These scores may be used by the insurance companies to determine the insurance premiums. In another embodiment, the computation module 201 may determine accident score for one or more vehicles. In one scenario, the computation module 201 may predict accident probability for a given vehicle in real time, for example, real time probability of a given vehicle (driverless or manually driven) to be involved in an accident. The computation module 201 may process vehicle sensor information (e.g., GPS information, brake sensor information, steering wheel sensor information), knowledge of the environment (e.g., weather, neighboring vehicles, road geometry), driver behavior (e.g., physiological behavior of a driver such as heart rate), or a combination thereof to compute score for a vehicle to get in an accident.

In one embodiment, the matching module 203 may cause a matching of at least one vehicle (e.g., location information via GPS) to one or more road maps or lane. Then, the matching module 203 may identify a set of locations traversed by the at least one vehicle.

In one embodiment, the monitoring module 205 may monitor the movement of one or more vehicles in real-time, periodically, according to schedule, on demand, or a combination thereof. In another embodiment, the monitoring module 205 may provide the matching module 203 with real-time location information for one or more vehicles. Then, the monitoring module 205 may receive map-matched data from the matching module 203, whereupon it may compute the frequency of one or more locations traversed by at least one vehicle.

In one embodiment, the communication module 207 may collect GPS data (e.g., location information) from the one or more vehicle, one or more users, or a combination thereof. Then, the communication module 207 may transmit the collected information to other modules. In another embodiment, the communication module 207 may collect the computed accident probability scores for one or more vehicles, and may transmit the collected scores to an insurance company. In one scenario, the communications strategy could vary; there may be periodic batch transmission or a real time transmission.

In one embodiment, the premium calculation module 209 may compute insurance rates based, at least in part, on the frequency of at least one vehicle traversing on a certain accident-prone location, the safety score for the location, or a combination thereof. In one scenario, the premium calculation module 209 may compare the scores registered by one or more vehicles to the standard accident probability score set by an insurance company. In one example embodiment, the premium calculation module 209 may adjust the insurance rate based, at least in part, on the frequency of the driver or vehicle on accident prone locations or accident probability of the driver or vehicle exceeding the insurance company's defined standard accident probability threshold, or a combination thereof. In one scenario, the evaluation platform 109 may have different threshold for different modes of vehicles (manual, partially autonomous, fully autonomous, etc.).

The above presented modules and components of the evaluation platform 109 can be implemented in hardware, firmware, software, or a combination thereof. Though depicted as a separate entity in FIG. 1A, it is contemplated that the evaluation platform 109 may be implemented for direct operation by respective UE 101s. As such, the evaluation platform 109 may generate direct signal inputs by way of the operating system of the UE 101 for interacting with the applications 103. In another embodiment, one or more of the modules 201-209 may be implemented for operation by respective UE 101s, as an evaluation platform 109, or combination thereof. Still further, the evaluation platform 109 may be integrated for direct operation with the services 115, such as in the form of a widget or applet, in accordance with an information and/or subscriber sharing arrangement. The various executions presented herein contemplate any and all arrangements and models.

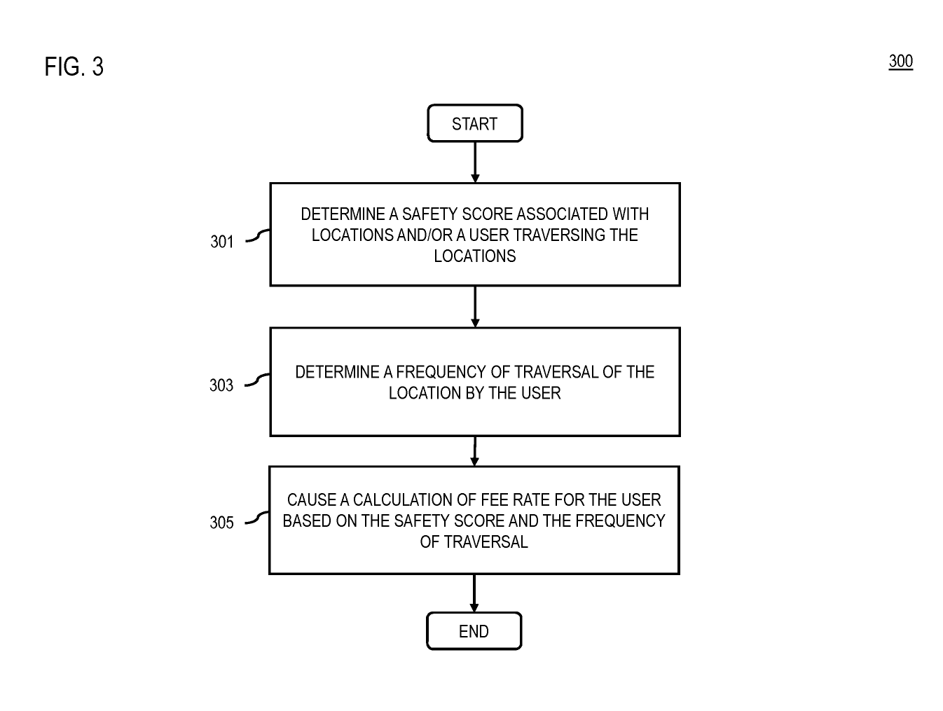

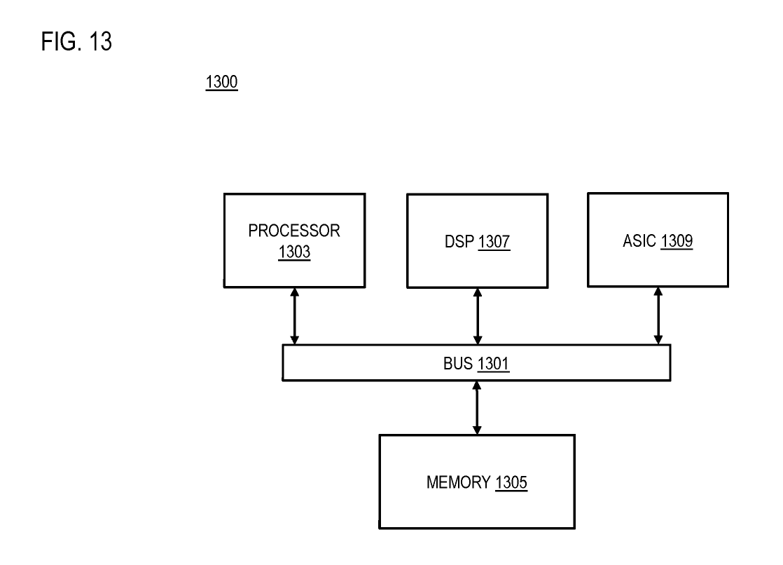

FIG. 3 is a flowchart of a process for determining safety score, frequency information, or a combination thereof to calculate fee rate, according to one embodiment. In one embodiment, the evaluation platform 109 performs the process 300 and is implemented in, for instance, a chip set including a processor and a memory as shown in FIG. 13.

In step 301, the evaluation platform 109 may determine at least one safety score associated with one or more locations, at least one user traversing the one or more locations, or a combination thereof. In one scenario, the evaluation platform 109 may evaluate one or more locations (e.g., intersections, road segments, etc.), and assign a safety score that represents the accident potential for the one or more locations. Then, the evaluation platform 109 may determine one or more users travelling on the one or more locations, whereupon the evaluation platform 109 may allocate a safety score to the one or more users. In one scenario, a user frequently walking in an accident prone location (e.g., sidewalk) may pay a higher insurance premium (e.g., health insurance, life insurance). In one example embodiment, a drone or a UAV flying in a high accident location or altitude may pay higher insurance.

In step 303, the evaluation platform 109 may determine at least one frequency of traversal of the at least one location by the at least one user. In one scenario, the evaluation platform 109 may determine frequency of travel for at least one vehicle, at least one user, or a combination thereof in at least one location based, at least in part, on map matching, historical location data, or a combination thereof.

In step 305, the evaluation platform 109 may cause, at least in part, a calculation of at least one fee rate for the at least one user based, at least in part, on the at least one safety score and the at least one frequency of traversal. In one embodiment, the at least one fee rate includes, at least in part, an insurance rate, a warranty rate, a transportation network use rate, a regulatory fee rate, or a combination thereof. In another embodiment, the at least one fee rate is associated with the at least one user, at least one user-operated vehicle, at least one autonomous vehicle, or a combination thereof. In one example embodiment, the evaluation platform 109 may modify the price of a premium for an autonomous vehicle. The autonomous vehicle that spends a high percentage of its time on high accident locations pays more insurance. In one example embodiment, the fee rate for a car rental (alongside the rental agreement) may vary depending upon the location the user is going to drive.

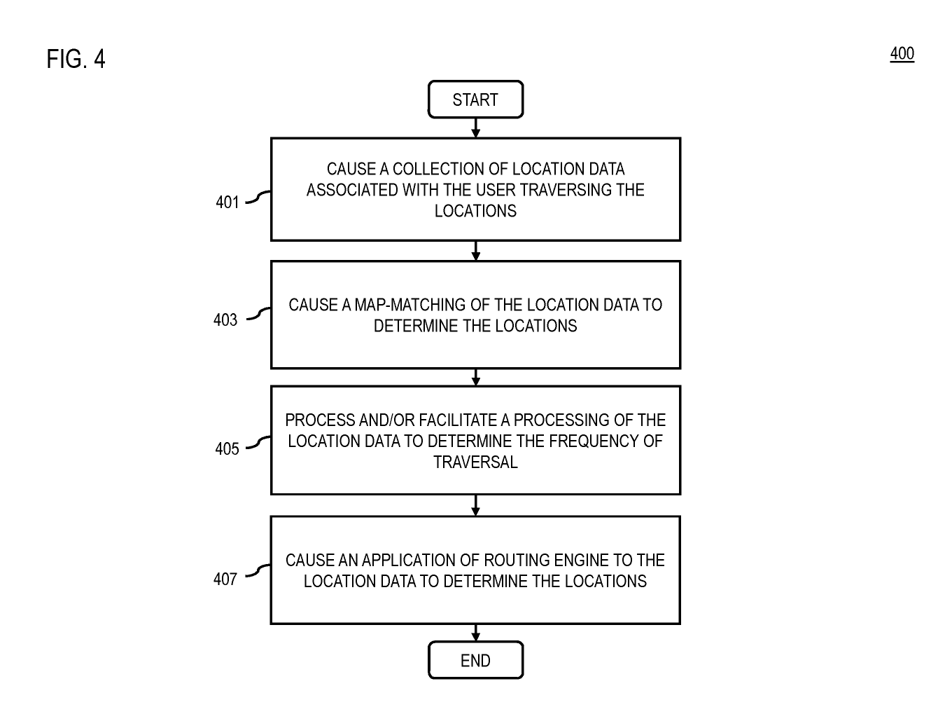

FIG. 4 is a flowchart of a process for determining frequency of traversal in one or more locations by one or more users, according to one embodiment. In one embodiment, the evaluation platform 109 performs the process 400 and is implemented in, for instance, a chip set including a processor and a memory as shown in FIG. 13.

In step 401, the evaluation platform 109 may cause, at least in part, a collection of location data associated with the at least one user traversing the one or more locations. In one scenario, the evaluation platform 109 may collect location data for at least one vehicle via sensor 105, for example, GPS receivers obtains geographic coordinates from satellites 119 for determining current location and time associated with the at least one vehicle. Then, the evaluation platform 109 may filter the GPS data to remove any errors.

In step 403, the evaluation platform 109 may cause, at least in part, a map-matching of the location data to determine the one or more locations since localization strategies such as GPS have inherent errors. In one scenario, the evaluation platform 109 may cause a map matching of the historical location data and/or the current location data associated with at least one vehicle, at least one user, or a combination thereof to determine the frequency of travel in one or more locations. Then, the evaluation platform 109 may associate accident potential based on the map matching to calculate insurance premiums location.

In step 405, the evaluation platform 109 location may process and/or facilitate a processing of the location data to determine the at least one frequency of traversal. In one scenario, the evaluation platform 109 may determine the characteristic for one or more locations, the one or more users, or a combination thereof.

In step 407, the evaluation platform 109 may cause, at least in part, an application of at least one routing engine to the location data to determine the one or more locations. In one embodiment, the application of the at least one routing engine to the location data is based on a determination that the location is sparse with respect to at least one threshold sparsity criteria.

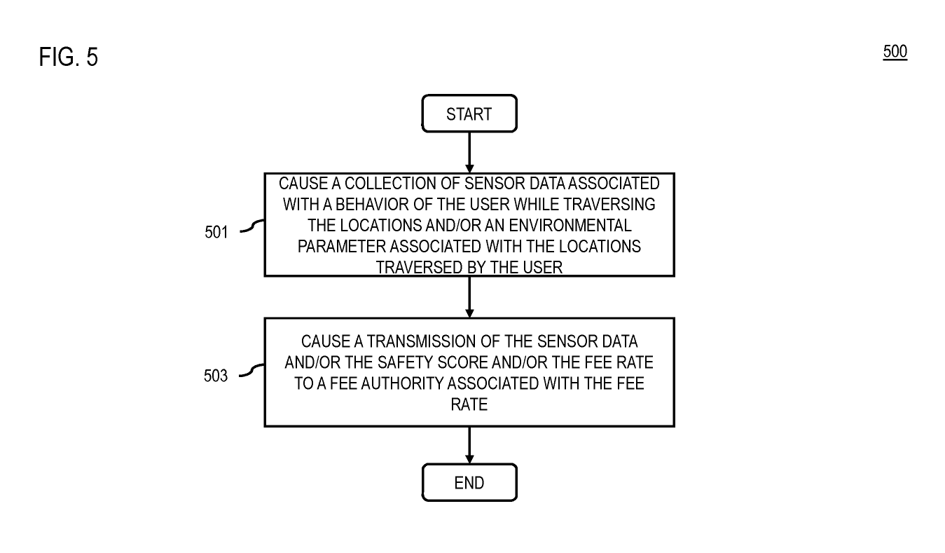

FIG. 5 is a flowchart of a process for collecting and transmitting sensor data to a fee authority associated with a fee rate, according to one embodiment. In one embodiment, the evaluation platform 109 performs the process 500 and is implemented in, for instance, a chip set including a processor and a memory as shown in FIG. 13.

In step 501, the evaluation platform 109 may cause, at least in part, a collection of sensor data associated with at least one behavior of the at least one user while traversing the one or more locations, at least one environmental parameter associated with the one or more locations traversed by the at least one user, or a combination thereof. In one embodiment, the at least one safety score is further based, at least in part, the sensor data. In one example embodiment, the evaluation platform 109 may cause a calculation of a personalized safety score for at least one vehicle in real-time based, at least in part, on sensor information, the road attributes, the user behavior, the environmental features, the temporal information, or a combination thereof. Then, the evaluation platform 109 may cause a transmission of the safety score in batch mode, real time mode, or a combination thereof.

In step 503, the evaluation platform 109 may cause, at least in part, a transmission of the sensor data, the at least one safety score, the at least one fee rate, or a combination thereof to at least one fee authority associated with the at least one fee rate. In one scenario, the at least one fee authority includes an insurance company or any other entity setting the fee rate. In one embodiment, the transmission is performed in at least substantially real-time, periodically, according to schedule, on-demand, or a combination thereof. In one scenario, the evaluation platform 109 may communicate accident probability information of each vehicle in real time to the insurance company as the vehicles drive along the locations. The evaluation platform 109 may implement various communication strategies, such as:
(a) Batch mode: In one scenario, the evaluation platform 109 may periodically transmit to the insurance company observed accident probability information obtained from the onboard accident probability computation software on a given vehicle. In another scenario, the evaluation platform 109 may transmit accident probability information on a daily basis, or when Wi-Fi communication is available, or under some other criteria based on convenience, reliability, cost, and sufficient frequency for the adjustments.
(b) Real time mode: In one scenario, as the vehicle drives, the evaluation platform 109 computes a personalized real time accident probability for the vehicle. The evaluation platform 109 may collect vehicular sensor data (e.g. speed, acceleration, steering wheel angle, tire pressure, brake pressure, etc.), road geometry data (e.g. slope, curvature), traffic (e.g. congestion level), and weather (e.g. surface temperature, snow, sleet, slippery road, visibility, etc.) to determine the chances of a vehicle to crash or observe a dangerous driving situation. Any existing system that computes accident probability may be used. In one scenario, the evaluation platform 109 does not have to be part of the vehicle. It can be on the attached device provided by the insurance company, or it can communicate the input information to a cloud where the information is processed, fused with other sources (weather, traffic, etc.), and ultimately scored. Furthermore, computation of accident probabilities of a vehicle in real-time may include regression models. There are several variants of real time mode for communicating accident probabilities to insurance companies from moving vehicles:
   (i) In one implementation, every X time-units (e.g. seconds) the vehicle's accident probability is sent to the insurance company;
   (ii) In another implementation, only when the insurance company's standard accident threshold is surpassed then the evaluation platform 109 transmits accident probability to the insurance company; and
   (iii) In another implementation, every Y time-units (e.g., seconds) the insurance company polls the vehicle for data including its score.

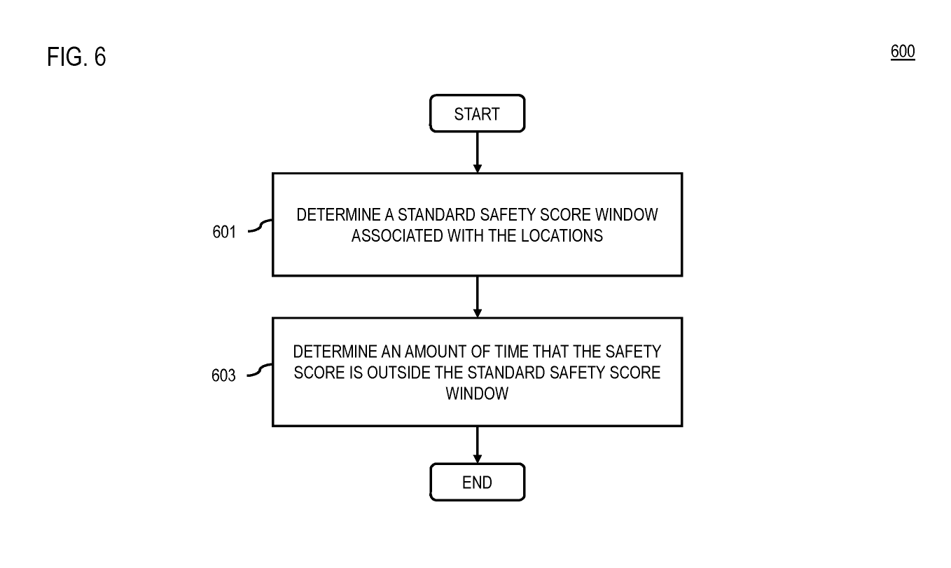

FIG. 6 is a flowchart of a process for determining the duration a safety score is outside a standard safety score window, according to one embodiment. In one embodiment, the evaluation platform 109 performs the process 600 and is implemented in, for instance, a chip set including a processor and a memory as shown in FIG. 13.

In step 601, the evaluation platform 109 may determine at least one standard safety score window associated with the one or more locations. In one embodiment, the at least one fee rate is used to modify at least one previously established fee rate if the at least one safety score is out the at least one standard safety score window. In one example embodiment, the evaluation platform 109 may determine a standard safety score window for the one or more vehicle, the one or more users, or a combination thereof travelling in the one or more locations. The standard safety score window may be a decimal or integer value per region (e.g., a country, a city, a bounding box, or even a stretch of road). The standard safety score window varies by region since the driving style, road geometry, weather, etc. differs across regions. For any given region, there can be multiple standard safety score windows. In one example embodiment, a single region may have one standard safety score window for night time and one for day time. In another example embodiment, a given region may have one standard safety score window for highways and one for arterial streets. The standard safety score window can also vary depending on weather conditions. Then, the evaluation platform 109 may cause a modification of the insurance rate for the one or more vehicles, the one or more users, or a combination thereof based, at least in part, on a comparison between the standard safety score window, and the safety score registered by the one or more vehicles, the one or more users, or a combination thereof. In one scenario, the standard safety score window varies based, at least in part, on road attributes, traffic density information, user behavior, environmental features, temporal information, or a combination thereof.

In step 603, the evaluation platform 109 may determine at least one amount of time that the at least one safety score is outside the at least one standard safety score window. In one embodiment, the at least one previously established fee rate is modified based, at least in part, on the at least one amount of time. In one example embodiment, the evaluation platform 109 may cause an increase in the insurance rate for the one or more vehicles, the one or more users, or a combination thereof based, at least in part, on a determination that the registered safety score surpasses the standard safety score window. Then, the evaluation platform 109 may add a value to the insurance rate for each time unit (e.g. minute) or a total time the safety score stays above the standard safety score window. In another example embodiment, each time a driver's accident probability surpasses the insurance company's standard safety score window a unit of money is added to the premium.

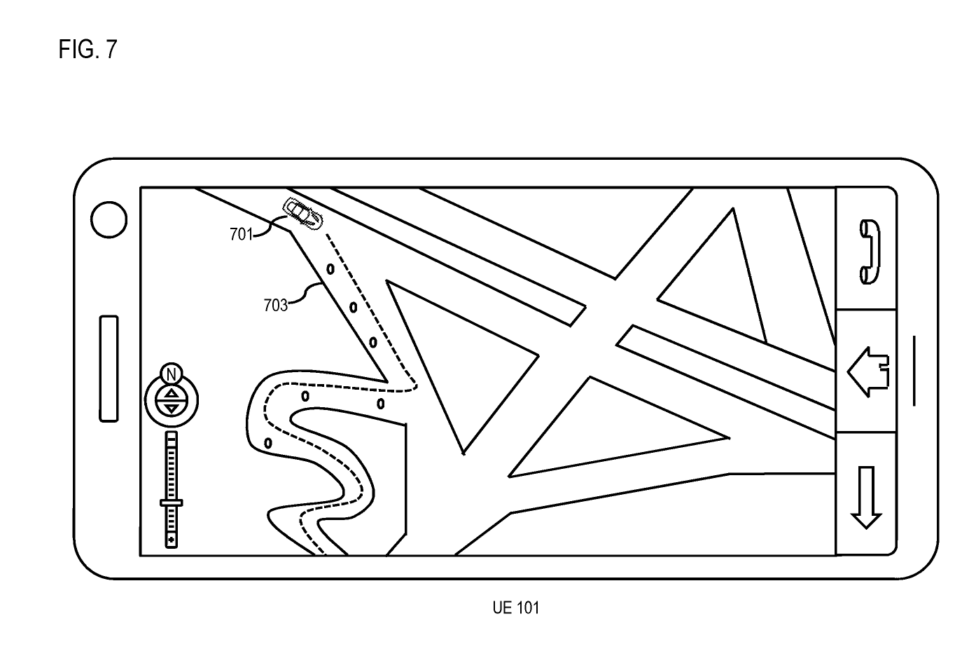

FIG. 7 is a diagram that represents a scenario wherein safety score for at least one vehicle is determined based on the attributes of a location, according to one example embodiment. In one scenario, the evaluation platform 109 may calculate the safety score for vehicle 701 traversing the location 703 based, at least in part, on the road surface, for example, location 703 may have a rough surface with numerous potholes. Such surface may cause wear and tear to the vehicle and may deteriorate its condition thereby increasing the warranty cost. Further, a rough road surface with potholes may affect the driving of a user. In another scenario, the evaluation platform 109 may calculate the safety score for the vehicle 703 based on the angle of the curves for the location 703. In one example embodiment, the evaluation platform 109 may calculate lower safety score for the vehicle 701 traversing through the narrower curves of the location 703. In another example embodiment, the fee rate for items within a vehicles (e.g., packages), passengers within a vehicle, or a combination thereof may increase if the vehicle is travelling accident prone road links.

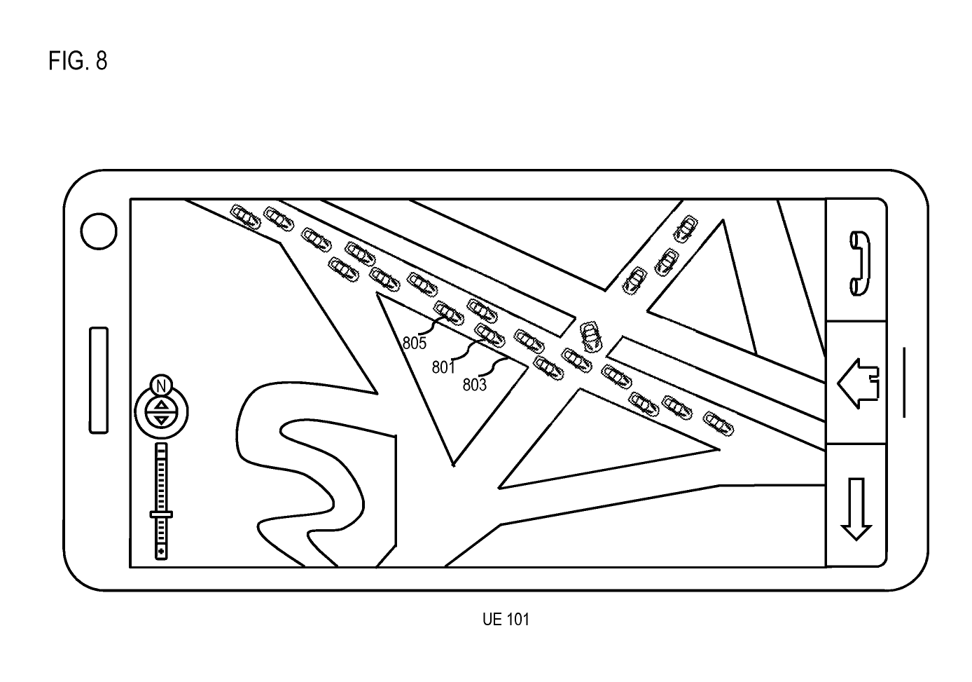

FIG. 8 is a diagram that represents a scenario wherein safety score for at least one vehicle is determined based on presence of other vehicles in the location, according to one example embodiment. In one scenario, the evaluation platform 109 may calculate the safety score for vehicle 801 traversing the location 803 based, at least in part, on the density of vehicles in the location 803. In another scenario, the evaluation platform 109 may calculate the safety score for vehicle 801 traversing the location 803 based, at least in part, on the maneuvering (e.g., driver's behavior) of the neighboring vehicles. Such calculation is possible based, at least in part, on peer-to-peer communication between the neighboring vehicles. In one example embodiment, the evaluation platform 109 may process the historical records for vehicle 805 and determine that it has a high potential for accident. Then, the evaluation platform 109 may calculate the safety score for vehicle 801 as low because of the presence of the vehicle 805 within close proximity. In another example embodiment, the safety score may vary depending on the type of neighboring vehicle (e.g., manually driver vehicle, autonomous vehicle, semi-autonomous vehicle).

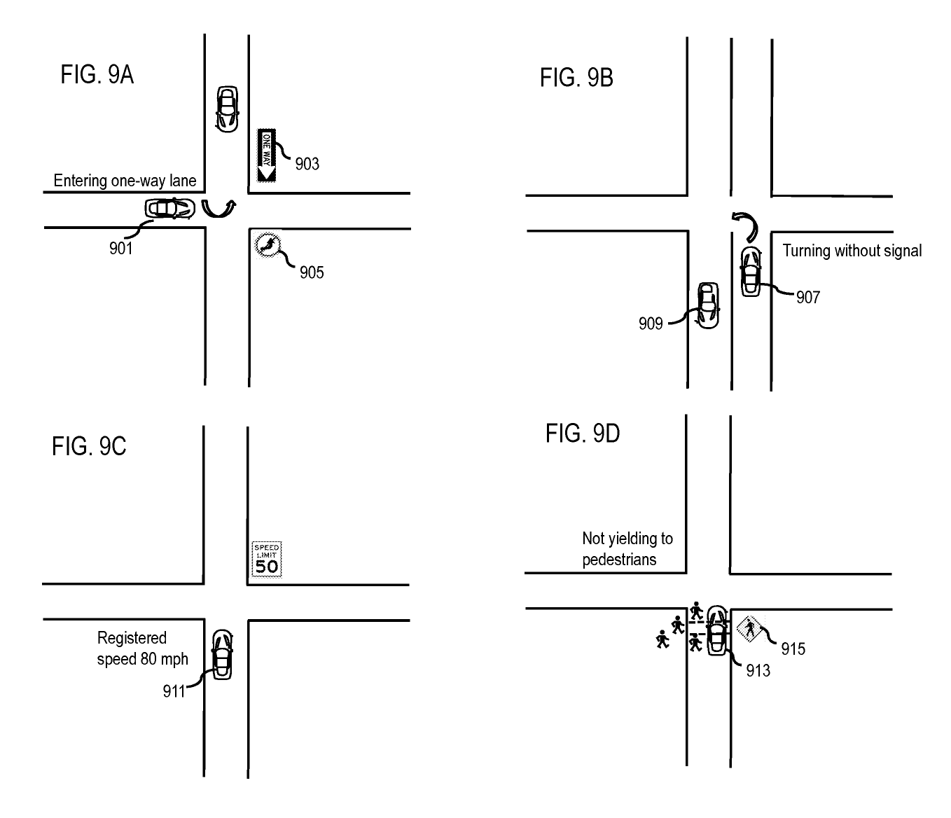

FIGS. 9 A-D are diagrams that represent a scenario wherein safety score for one or more vehicles is calculated based on user behavior, according to one example embodiment. In one scenario, the evaluation platform 109 may track the behaviors of the one or more drivers. In FIG. 9A the driver of the vehicle 901 is making a left turn in a one way street and ignoring the traffic sign 903 and 905. In FIG. 9B the driver of the vehicle 907 is being careless by turning left without a left-turn signal, thereby likely to crash into vehicle 909. In FIG. 9C the driver of the vehicle 911 is being reckless by driving 80 mph, and exceeding the traffic speed limit of 50 mph. In FIG. 9D the driver of the vehicle 913 is not yielding to the crossing pedestrian despite the traffic sign 915 and the knowledge of pedestrians crossing the street. In one embodiment, the evaluation platform 109 may monitor the aforementioned violation of traffic rules and regulations by the one or more users. Then, the evaluation platform 109 may calculate the safety score for one or more users based on the monitoring.

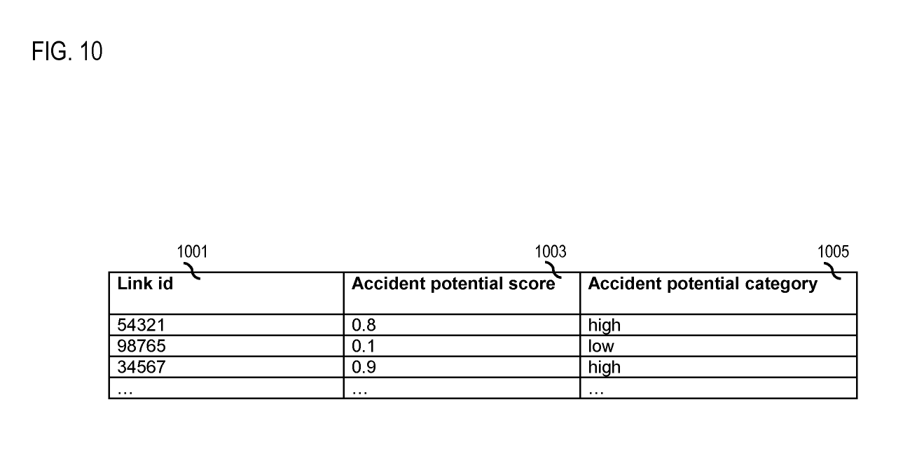

FIG. 10 is a graphical diagram that represents the computing of an accident potential score or an accident potential category at the link level, according to one example embodiment. In one scenario, the link ID 1001 represents the map element that denotes the location. In one scenario, the accident potential score 1003 is a numerical value that measures the probability for accident to occur in a certain time period on the considered location. In one scenario, the accident potential category 1005 is a categorical expression of the accident potential score. In one embodiment, the evaluation platform 109 may use either the accident potential score or the accident potential category variables during the training of the pricing model. For example, a classification evaluation platform could consider the categories while a regression evaluation platform considers the raw scores. Then, the evaluation platform 109 may perform map matching operations to determine how frequent a driver traverses the high accident locations. The evaluation platform 109 may collect historical GPS data from one or more drivers and/or one or more vehicles via special GPS enabled device provided by a fee authority (e.g., an insurance company), or by any other means (e.g., sensors 105) that allows for ascertaining the route of a vehicle. After map matching the driver's location data, the evaluation platform 109 may determine the locations driven historically and the frequency of drives on these locations. Then, the evaluation platform 109 may compute automotive insurance cost per driver based on the frequency and the accident potential score. In one scenario, any strategy that computes an insurance premium based on the frequency of the driver on accident prone links is implemented.

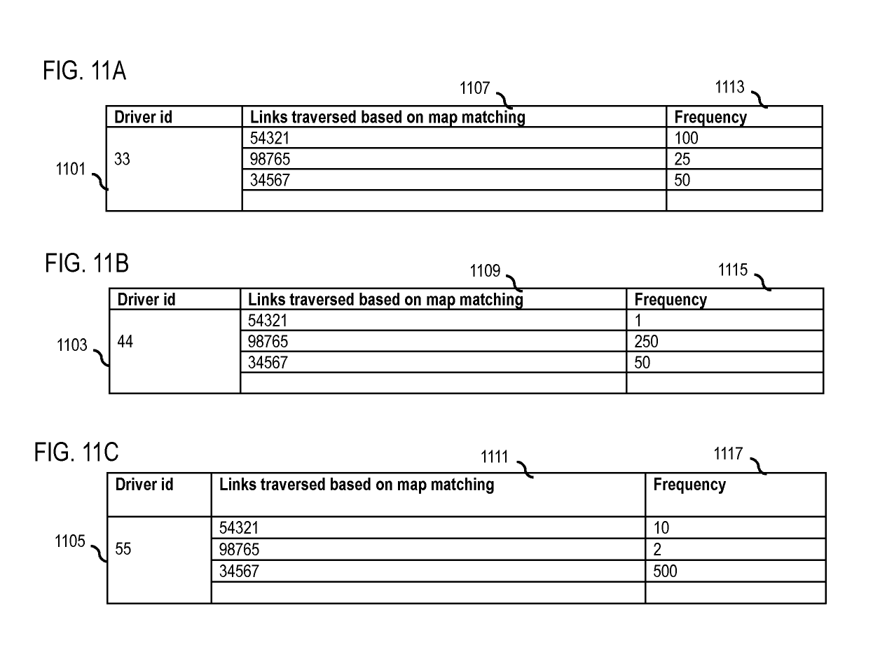

FIGS. 11 A-C are graphical diagrams that represents different drivers (1101, 1103, 1105), the links that were traversed as determined by the map matching process (1107, 1109, 1111), and the frequency of drives on these links (1113, 1115, 1117), according to one example embodiment. In one embodiment, the evaluation platform 109 may use the driver's historical GPS data, and may map match the historical GPS data to determine the locations that were traversed by the driver. In one scenario, the GPS data observed may be sparse (e.g. >5 seconds) whereupon the evaluation platform 109 may overlook shorter links. Subsequently, the evaluation platform 109 may use a router between the two consecutive GPS points to determine all links between the two sparse GPS points. In one scenario, the evaluation platform 109 may implement the following strategy to determine the relative per driver auto insurance payments:

$${\sum }_{i = 1}^{n} ( frequency * accident potential ) / {\sum }_{i = 1}^{n} frequency$$

In one embodiment, ‘n’ is the number of links traversed by a driver.

For driver 33 (1101) this strategy would yield the following result:

(100*0.8)+(25*0.1)+(50*0.9)=127.5/175=0.73.

For driver 44 (1103) this strategy would yield the following result:

(1*0.8)+(250*0.1)+(50*0.9)=70.8/301=0.24.

For driver 55 (1105) this strategy would yield the following result:

(10*0.8)+(2*0.1)+(500*0.9)=458.2/512=0.89.

This above calculation implies that driver 55 (1105) pays more for auto insurance than driver 33 (1101) who in turn pays more than driver 44 (1103). The provided example is for illustration purposes and does not limit the pricing model to the one expressed by the above equation.

The processes described herein for determining safety scores for locations, frequency of users traversing the locations, or a combination thereof to calculate fee rates may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

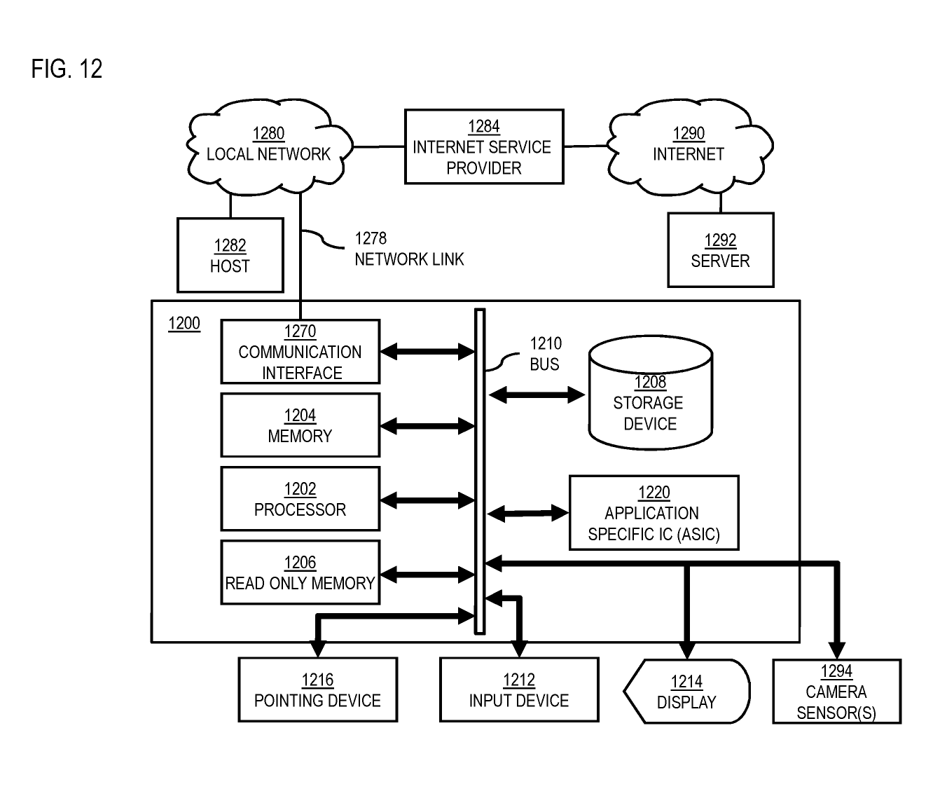

FIG. 12 illustrates a computer system 1200 upon which an embodiment of the invention may be implemented. Although computer system 1200 is depicted with respect to a particular device or equipment, it is contemplated that other devices or equipment (e.g., network elements, servers, etc.) within FIG. 12 can deploy the illustrated hardware and components of system 1200. Computer system 1200 is programmed (e.g., via computer program code or instructions) to determine safety scores for locations, frequency of users traversing the locations, or a combination thereof to calculate fee rates as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of determining safety scores for locations, frequency of users traversing the locations, or a combination thereof to calculate fee rates.

A bus 1210 includes one or more parallel conductors of information so that information is transferred quickly among devices coupled to the bus 1210. One or more processors 1202 for processing information are coupled with the bus 1210.

A processor (or multiple processors) 1202 performs a set of operations on information as specified by computer program code related to determining safety scores for locations, frequency of users traversing the locations, or a combination thereof to calculate fee rates. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1200 also includes a memory 1204 coupled to bus 1210. The memory 1204, such as a random access memory (RAM) or any other dynamic storage device, stores information including processor instructions for determining safety scores for locations, frequency of users traversing the locations, or a combination thereof to calculate fee rates. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or any other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for determining safety scores for locations, frequency of users traversing the locations, or a combination thereof to calculate fee rates, is provided to the bus 1210 for use by the processor from an external input device 1212, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT), a liquid crystal display (LCD), a light emitting diode (LED) display, an organic LED (OLED) display, a plasma screen, or a printer for presenting text or images, and a pointing device 1216, such as a mouse, a trackball, cursor direction keys, or a motion sensor, for controlling a position of a small cursor image presented on the display 1214 and issuing commands associated with graphical elements presented on the display 1214, and one or more camera sensors 1294 for capturing, recording and causing to store one or more still and/or moving images (e.g., videos, movies, etc.) which also may comprise audio recordings. In some embodiments, for example, in embodiments in which the computer system 1200 performs all functions automatically without human input, one or more of external input device 1212, display device 1214 and pointing device 1216 may be omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of ASICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the communication network 107 for determining safety scores for locations, frequency of users traversing the locations, or a combination thereof to calculate fee rates to the UE 101.

The term “computer-readable medium” as used herein refers to any medium that participates in providing information to processor 1202, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1208. Volatile media include, for example, dynamic memory 1204. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1220.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290.

A computer called a server host 1292 connected to the Internet hosts a process that provides a service in response to information received over the Internet. For example, server host 1292 hosts a process that provides information representing video data for presentation at display 1214. It is contemplated that the components of system 1200 can be deployed in various configurations within other computer systems, e.g., host 1282 and server 1292.

At least some embodiments of the invention are related to the use of computer system 1200 for implementing some or all of the techniques described herein. According to one embodiment of the invention, those techniques are performed by computer system 1200 in response to processor 1202 executing one or more sequences of one or more processor instructions contained in memory 1204. Such instructions, also called computer instructions, software and program code, may be read into memory 1204 from another computer-readable medium such as storage device 1208 or network link 1278. Execution of the sequences of instructions contained in memory 1204 causes processor 1202 to perform one or more of the method steps described herein. In alternative embodiments, hardware, such as ASIC 1220, may be used in place of or in combination with software to implement the invention. Thus, embodiments of the invention are not limited to any specific combination of hardware and software, unless otherwise explicitly stated herein.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server host 1292 transmits program code for a particular application, requested by a message sent from computer 1200, through Internet 1290, ISP equipment 1284, local network 1280 and communications interface 1270. The received code may be executed by processor 1202 as it is received, or may be stored in memory 1204 or in storage device 1208 or any other non-volatile storage for later execution, or both. In this manner, computer system 1200 may obtain application program code in the form of signals on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

FIG. 13 illustrates a chip set or chip 1300 upon which an embodiment of the invention may be implemented. Chip set 1300 is programmed to determine safety scores for locations, frequency of users traversing the locations, or a combination thereof to calculate fee rates as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1300 can be implemented in a single chip. It is further contemplated that in certain embodiments the chip set or chip 1300 can be implemented as a single “system on a chip.” It is further contemplated that in certain embodiments a separate ASIC would not be used, for example, and that all relevant functions as disclosed herein would be performed by a processor or processors. Chip set or chip 1300, or a portion thereof, constitutes a means for performing one or more steps of providing user interface navigation information associated with the availability of functions. Chip set or chip 1300, or a portion thereof, constitutes a means for performing one or more steps of determining safety scores for locations, frequency of users traversing the locations, or a combination thereof to calculate fee rates.

In one embodiment, the chip set or chip 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1300 includes merely one or more processors and some software and/or firmware supporting and/or relating to and/or for the one or more processors.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to determine safety scores for locations, frequency of users traversing the locations, or a combination thereof to calculate fee rates. The memory 1305 also stores the data associated with or generated by the execution of the inventive steps.

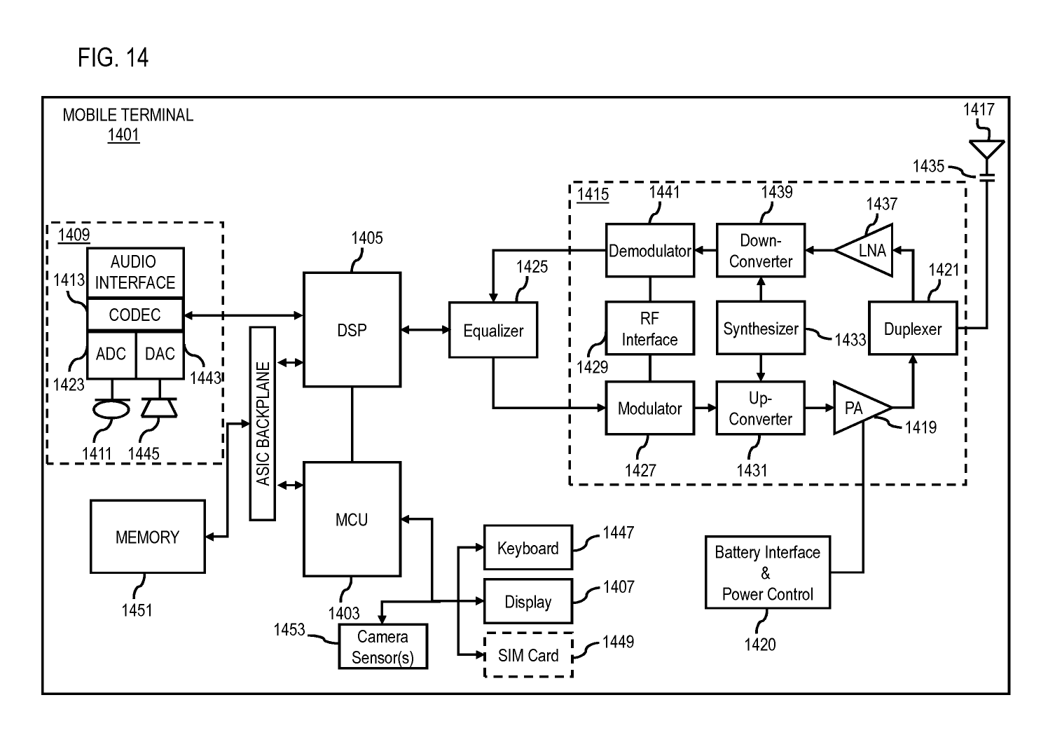

FIG. 14 is a diagram of exemplary components of a mobile terminal (e.g., handset) for communications, which is capable of operating in the system of FIG. 1A, according to one embodiment. In some embodiments, mobile terminal 1401, or a portion thereof, constitutes a means for performing one or more steps of determining safety scores for locations, frequency of users traversing the locations, or a combination thereof to calculate fee rates. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile terminal functions that perform or support the steps of determining safety scores for locations, frequency of users traversing the locations, or a combination thereof to calculate fee rates. The display 1407 includes display circuitry configured to display at least a portion of a user interface of the mobile terminal (e.g., mobile telephone). Additionally, the display 1407 and display circuitry are configured to facilitate user control of at least some functions of the mobile terminal. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile terminal 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403 which can be implemented as a Central Processing Unit (CPU).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile terminal 1401 to determine safety scores for locations, frequency of users traversing the locations, or a combination thereof to calculate fee rates. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the terminal. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile terminal 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable storage medium known in the art. The memory device 1451 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1449 carries, for instance, important information, such as the cellular phone number, the carrier supplying service, subscription details, and security information. The SIM card 1449 serves primarily to identify the mobile terminal 1401 on a radio network. The card 1449 also contains a memory for storing a personal telephone number registry, text messages, and user specific mobile terminal settings.

Further, one or more camera sensors 1453 may be incorporated onto the mobile station 1401 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining at least one safety score associated with one or more locations, at least one user traversing the one or more locations, or a combination thereof;
determining at least one frequency of traversal of the at least one location by the at least one user; and
causing, at least in part, a calculation of at least one fee rate for the at least one user based, at least in part, on the at least one safety score and the at least one frequency of traversal.

2. A method of claim 1, wherein the at least one fee rate includes, at least in part, an insurance rate, a warranty rate, a transportation network use rate, a regulatory fee rate, or a combination thereof; and wherein the at least one fee rate is associated with the at least one user, at least one user-operated vehicle, at least one autonomous vehicle, or a combination thereof.

3. A method of claim 1, further comprising:
causing, at least in part, a collection of location data associated with the at least one user traversing the one or more locations; and
processing and/or facilitating a processing of the location data to determine the at least one frequency of traversal.

4. A method of claim 3, further comprising:
causing, at least in part, a map-matching of the location data to determine the one or more locations.

5. A method of claim 3, further comprising:
causing, at least in part, an application of at least one routing engine to the location data to determine the one or more locations.

6. A method of claim 5, wherein the application of the at least one routing engine to the location data is based on a determination that the location is sparse with respect to at least one threshold sparsity criteria.

7. A method of claim 1, further comprising:
causing, at least in part, a collection of sensor data associated with at least one behavior of the at least one user while traversing the one or more locations, at least one environmental parameter associated with the one or more locations traversed by the at least one user, or a combination thereof,
wherein the at least one safety score is further based, at least in part, the sensor data.

8. A method of claim 7, further comprising:
causing, at least in part, a transmission of the sensor data, the at least one safety score, the at least one fee rate, or a combination thereof to at least one fee authority associated with the at least one fee rate,
wherein the transmission is performed in at least substantially real-time, periodically, according to schedule, on-demand, or a combination thereof.

9. A method of claim 1, further comprising:
determining at least one standard safety score window associated with the one or more locations,
wherein the at least one fee rate is used to modify at least one previously established fee rate if the at least one safety score is out the at least one standard safety score window.

10. A method of claim 8, further comprising:
determining at least one amount of time that the at least one safety score is outside the at least one standard safety score window,
wherein the at least one previously established fee rate is modified based, at least in part, on the at least one amount of time.

11. An apparatus comprising:
at least one processor; and
at least one memory including computer program code for one or more programs,
the at least one memory and the computer program code configured to, with the at least one processor, cause the apparatus to perform at least the following;
determine at least one safety score associated with one or more locations, at least one user traversing the one or more locations, or a combination thereof;
determine at least one frequency of traversal of the at least one location by the at least one user; and
cause, at least in part, a calculation of at least one fee rate for the at least one user based, at least in part, on the at least one safety score and the at least one frequency of traversal.

12. An apparatus of claim 11, wherein the at least one fee rate includes, at least in part, an insurance rate, a warranty rate, a transportation network use rate, a regulatory fee rate, or a combination thereof; and wherein the at least one fee rate is associated with the at least one user, at least one user-operated vehicle, at least one autonomous vehicle, or a combination thereof.

13. An apparatus of claim 11, wherein the apparatus is further caused to:
cause, at least in part, a collection of location data associated with the at least one user traversing the one or more locations; and
process and/or facilitate a processing of the location data to determine the at least one frequency of traversal.

14. An apparatus of claim 13, wherein the apparatus is further caused to:
cause, at least in part, a map-matching of the location data to determine the one or more locations.

15. An apparatus of claim 13, wherein the apparatus is further caused to:
cause, at least in part, an application of at least one routing engine to the location data to determine the one or more locations.

16. An apparatus of claim 15, wherein the application of the at least one routing engine to the location data is based on a determination that the location is sparse with respect to at least one threshold sparsity criteria.

17. An apparatus of claim 11, wherein the apparatus is further caused to:
cause, at least in part, a collection of sensor data associated with at least one behavior of the at least one user while traversing the one or more locations, at least one environmental parameter associated with the one or more locations traversed by the at least one user, or a combination thereof,
wherein the at least one safety score is further based, at least in part, the sensor data.

18. A computer-readable storage medium carrying one or more sequences of one or more instructions which, when executed by one or more processors, cause an apparatus to perform:
determining at least one safety score associated with one or more locations, at least one user traversing the one or more locations, or a combination thereof;
determining at least one frequency of traversal of the at least one location by the at least one user; and
causing, at least in part, a calculation of at least one fee rate for the at least one user based, at least in part, on the at least one safety score and the at least one frequency of traversal.

19. A computer-readable storage medium of claim 18, wherein the apparatus is further caused to perform:
causing, at least in part, a collection of location data associated with the at least one user traversing the one or more locations; and
processing and/or facilitating a processing of the location data to determine the at least one frequency of traversal.

20. A computer-readable storage medium of claim 18, wherein the apparatus is further caused to:
causing, at least in part, a map-matching of the location data to determine the one or more locations.

21.-48. (canceled)
